(19) United States
(12) Patent Application Publication
(10) Pub. No.: US 2004/0204831 A1
(43) Pub. Date: Oct. 14, 2004

(54) System and method of locating a resource device from a wireless device

(76) Inventors: Denis Pochuev, Camas, WA (US); Trevor Wells, Vancouver, WA (US); Paul Walrath, Battle Ground, WA (US)

Correspondence Address: HEWLETT- PACKARD COMPANY, Intellectual Property Administration, P.O. Box 272400, Fort Collins, CO, 80527-2400, US

(21) Appl. No.: 10/285,143

(22) Filed: Oct. 30, 2002

(51) Int. Cl. G01C 21/00

(52) U.S. Cl. 701/207; 455/456.1

(57) ABSTRACT

A system and method of determining a location of a resource device relative to a wireless computing device are provided. The system typically includes receiving a wireless search signal from the wireless device at each of the resource device and a locating device, and calculating a position of the resource device relative to the wireless computing device based on characteristics of the wireless search signal detected at each of the locating device and the resource device.

### BACKGROUND

Wireless computing devices, such as Portable Data Assistants (PDAs), have grown increasingly popular in recent years due to their compact size and wireless connectivity. In a familiar environment, a user easily may connect a wireless computing device to a known resource device, such as a printer, via a wireless communication link in order to print a document. In an unfamiliar environment, however, it often becomes problematic for a user to locate a desired resource device. For example, a user waiting for a flight at an airport may desire to print a flight schedule from a PDA. But, the user may not know whether the airport is equipped with a printer for the use of airport guests, or may not know the precise location of such a printer, if it exists. Searching for a printer may waste the time of the user, resulting in lost productivity, frustration, and possibly a missed flight.

### SUMMARY

A system and method of determining a location of a resource device relative to a wireless computing device are provided. The method typically includes receiving a wireless search signal from the wireless device at each of the resource device and a locating device, and calculating a position of the resource device relative to the wireless computing device based on characteristics of the wireless search signal detected at each of the locating device and the resource device.

### BRIEF DESCRIPTION OF THE DRAWINGS

FIG. 1 is a schematic view of a system for determining the position of a resource device relative to a wireless device, according to one embodiment of the present invention.

FIG. 2 is a front view of a wireless device of the system of FIG. 1, showing a graphical user interface.

FIG. 3 is a schematic view of the system of FIG. 1, showing geometry for calculating the position of the resource device relative to the wireless device.

FIG. 4 is a schematic view of set-up parameters of the system of FIG. 1.

FIG. 5 is a schematic view of detected and calculated parameters of the system of FIG. 1.

FIG. 6 is a schematic view of the system of FIG. 1, showing communication between a resource device and a plurality of wireless devices.

FIG. 7 shows a method for determining a location of a resource device relative to a wireless computing device, according to one embodiment of the present invention.

FIG. 8 shows a method for determining a distance and a direction from a wireless device to a resource device, according to another embodiment of the present invention.

### DETAILED DESCRIPTION

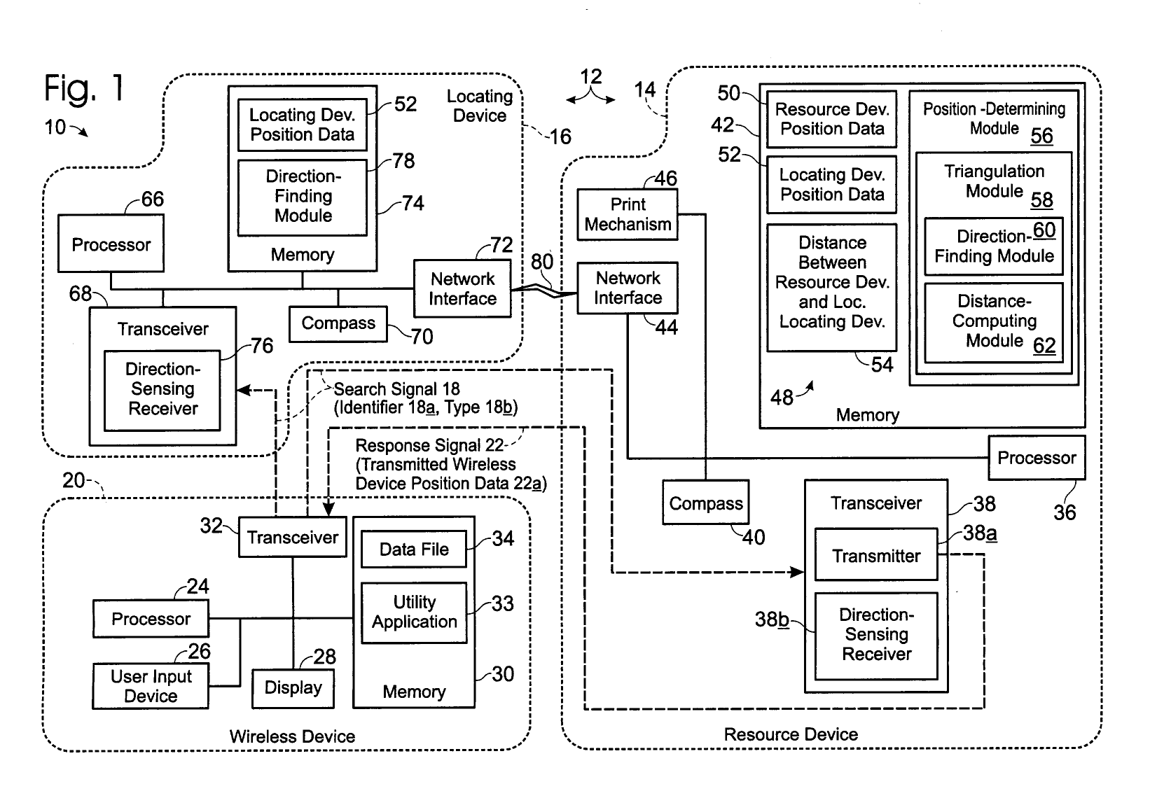

FIG. 1 shows, generally at 10, a system including static devices 12 such as resource device 14 and locating device 16, which are configured to receive a search signal 18 from a wireless device 20, and in response to transmit to the wireless device a response signal 22 indicating the position of the wireless device relative to the resource device. It will be appreciated that static devices 12 are typically positioned in fixed locations, while wireless device 20 is typically a mobile device that is free to be carried about by a user. It will further be appreciated that while signal 18 is referred to here in as a search signal, virtually any type of wireless signal or signals emitted from wireless device 20 may be used by static devices 12 to determine the position of the wireless device.

Wireless device 20 is typically a wireless computing device, such as a portable computer, a portable data assistant, or a wireless telephone. Alternatively, wireless device 20 may be virtually any other electronic device having wireless communications ability. Wireless device 20 typically includes a processor 24 linked via a communications bus to a user input device 26 (such as a keyboard), a display 28, memory 30, and a transceiver 32. Memory 30 typically includes a combination of volatile and nonvolatile memory, such as RAM, ROM, flash memory, hard disk memory, etc.

A utility application 33 and one or more data files 34 are typically stored in memory 30. In response to a user command, processor 24 is configured to execute utility application 33, and to perform a requested action on resource device 14 using data file 34. Typically, data file 34 is a document file, resource device 14 is a printing device, and utility application 33 is a print utility configured to print a document on resource device 14. As used herein, the term printing device is meant to include printers, facsimile machines, copiers, and so-called “all-in-one” machines incorporating several of these functions, as well as any other device capable of printing a document or other data on a print medium. It will also be appreciated that other types of resource devices and utility applications may also be utilized. For example, the resource device may be a scanner, network connection device, electronic kiosk or store, etc., and the utility application may be a program configured to enable the wireless device to interact with each of these devices.

Typically, transceiver 32, like the transceivers of resource device 14 and locating device 16 (discussed below), is configured to communicate using a short-range wireless technology, such as the wireless technology employed in the Bluetooth and/or IEEE 802.11 standards, both of which are widely recognized in the industry. Alternatively, the transceivers may communicate via other suitable wireless transmission methods, at other frequencies, and/or according to other suitable protocols.

Typically, the position calculation methods according to the present invention using these short range wireless technologies enable the position of the wireless device relative to the resource device to be calculated with a high degree of accuracy, typically within +/−5 meters, and more typically within +/−1 meter. This represents a vast improvement over prior GPS based position detection systems, which are typically only accurate to within +/−15 meters for each device, resulting in a possible error of +/−30 meters for the distance between two devices.

Transceiver 32 of wireless device 20 typically is configured to transmit a wireless search signal 18 to static devices 12, and receive a wireless response signal 22 in return. Search signal 18 typically contains a wireless device identifier 18a, which specifically identifies the wireless device 20, as well as resource device type data 18b, indicating the type of resource device for which the wireless device is searching. Wireless device identifier 18a may be used, for example, to distinguish among a plurality of search and response signals 18, 22, simultaneously being sent between a plurality of wireless devices and static devices. The resource device type data typically is recognized by resource device 14, and resource device 14 is configured to respond if it is of the identified type. Exemplary resource device types include printers, facsimile devices, copiers, scanners, etc.

Resource device 14 typically includes a processor 36, linked by a bus to a transceiver 38, compass 40, memory 42, network interface 44, and print mechanism 46. Transceiver 38 typically includes a transmitter 38a configured to transmit response signal 22 to wireless device 20. Transceiver 38 typically further includes a direction-sensing receiver 38b configured to sense the direction (angle C in FIGS. 3 and 5) from which the search signal 18 is transmitted, i.e. the direction of wireless device 20 from resource device 14. Print mechanism 46 is typically configured to print a print job from a wireless device on a print medium, such as paper.

As used herein the term “compass” typically refers to a hardware element configured to detect North, or some other fixed reference direction, while “direction-finding module” is used to refer to a program that is configured to be executed by a device and receive input from a compass and a direction-sensing receiver, and, based on these inputs, to determine the direction of a given signal relative to North. Compass 40 may be a suitable magnetic compass or non-magnetic device configured to indicate direction.

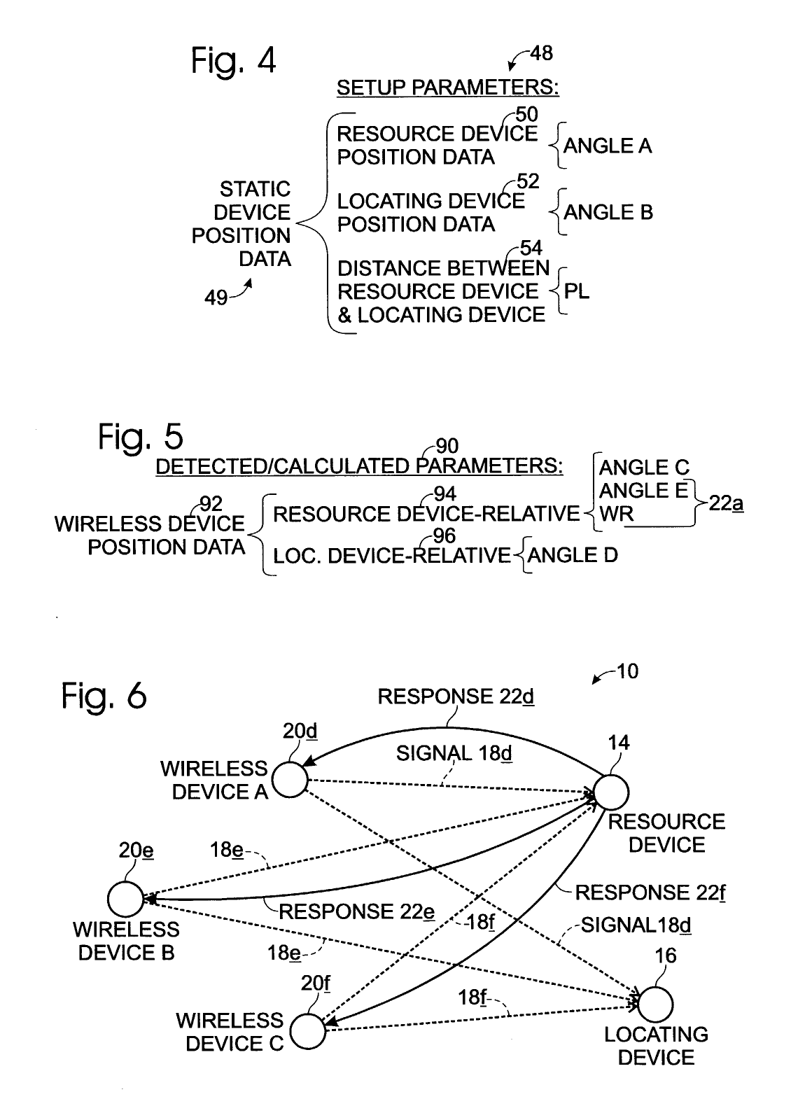

Resource device 14 is typically pre-programmed upon set-up with set-up parameters 48. As shown in FIG. 4, set-up parameters 48 typically include static device position data 49 such as resource device position data 50, locating device position data 52, and a calculated distance 54 between resource device 14 and locating device 16. Exemplary parameters for each of these data types are listed in FIG. 4 and geometrically illustrated in FIG. 3. For example, the resource device position data 50 may include angle A; locating device position data 52 may include angle B; and distance 54 may include line segment RL. Of course other measurements, coordinates, etc. may be used to indicate the positions of static devices 12.

Resource device 14 also typically includes a position-determining module 56 (FIG. 1) configured to determine a position of the resource device relative to the wireless device. Alternatively, this module may be executed by locating device 16, or another external device configured to communicate with the resource device and locating device via a network. Position determining module 56 typically includes a triangulation engine 58 having a direction-finding module 60 and a distance-computing module 62, the functions of each of which will be described in detail below.

Locating device 16 typically includes a processor 66 linked by a communication bus to a transceiver 68, compass 70, network interface 72, and memory 74. Transceiver 68 typically includes a direction-sensing receiver 76, and memory 74 typically includes a direction-finding module 78. Direction-sensing receiver 76 is configured to receive search signal 18, while direction-sensing module 78 is typically one or more programs configured to process search signal 18 in order to determine the direction (angle D) of wireless device 20 from the locating device, based on characteristics of search signal 18 received at receiver 76. Direction-finding module 78 typically acts in connection with compass 70 to measure the direction of search signal 18 from the locating device relative to North, although another suitable frame of reference may be used.

Locating device position data 52, such as the direction (angle B) of resource device 14 from the locating device 16 relative to North, is typically input into memory of the locating device 16 and/or the resource device 14. Network interface 72 is typically configured to transfer the locating device position data 52 (e.g. angle B) and the calculated direction of the wireless device (e.g. angle D) to resource device 14 via communication link 80 (FIG. 1). Communication link 80 may be virtually any type of wired or wireless data transfer network.

It will be understood that as used herein, the term “locating device” refers to virtually any device that includes a wireless receiver for receiving a wireless search signal from wireless device 20, and on-board or off-board processing functionality for calculating the direction from which the wireless search signal originated. As discussed above, the term “resource device” refers to a device that is configured to exchange data with wireless device 20 to accomplish a user-specified function. The user-specified function may be a document input/output operation, such as printing, faxing, copying, scanning, etc., a network connectivity operation, such as connecting to a broadband or dial-up network, etc., a shopping function such as locating a kiosk or store, a data transfer operation such as downloading information from a data station, or virtually any other function that a user desires to perform from a wireless device using a static resource device. Suitable resource device type data 18b for each of these types of functions may be utilized.

It will be appreciated that, in the depicted embodiment, resource device 14 is also a locating device, but is referred to primarily as a resource device, and in some instances, a printing device. According to another embodiment of the invention, two or more static locating devices may be provided, and a resource device may be provided with no locating functionality. In this embodiment, the two static devices measure characteristics of search signal 18, and one of the static devices (or alternatively, a fourth device) may be used to transmit position information for the resource device to the wireless device. According to yet another embodiment of the invention, two or more resource devices, such as printing devices, may be provided, each of which acts as a locating device.

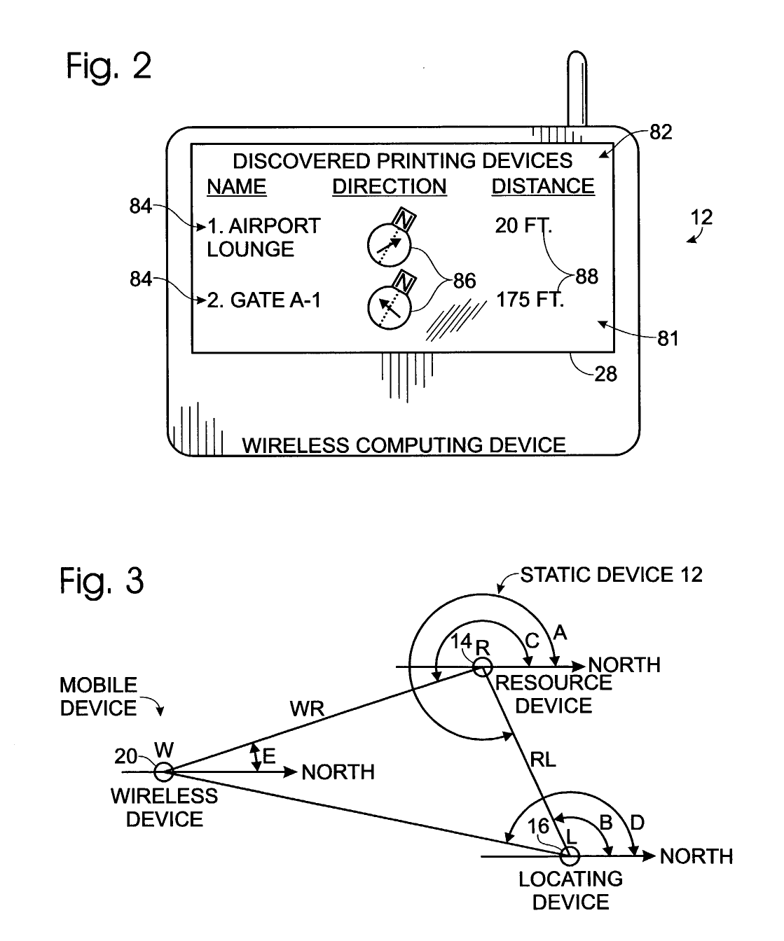

As shown in FIG. 2, wireless computing device 20 may take the form of a portable computing device including a display 28 configured to display a graphical user interface 81 with a list 82 of discovered resource devices 84, such as printing devices. This list is typically displayed in response to a user command to search for surrounding resource devices, although it is contemplated that the devices might announce themselves to the wireless device. For each of the detected resource devices, the graphical user interface is further configured to include a direction icon 86 indicating a direction from the wireless device to the corresponding resource device, and a distance icon 88 indicating a distance from the wireless device to the corresponding resource device. The direction icon may also indicate a fixed direction, such as North. In this manner, the user may walk in the general direction of the resource device, carrying the wireless device, in order to physically approach the device. The direction and distance icon are typically updated periodically in real time as the wireless device location is changed, based on new wireless device position data 92 (FIG. 5) detected by the static devices 12 and transmitted from the static devices to wireless computing device 20 via response signal 22. Alternatively, it will be appreciated that wireless device 20 may be a portable computer, wireless telephone, or other wireless device configured to display graphical user interface 81.

FIG. 3 shows a geometric representation of the triangulation process by which system 10 may determine the position and direction of resource device 14 relative to wireless device 20. As discussed above, during installation of the resource device and locating device, various set-up parameters 48 are typically input into system 10. Specifically, the distance RL between the resource device and locating device is measured and entered into memory 42 of resource device, as distance 54. In addition, angle B is measured by the compass of the resource device and entered into memory as location device position data 52, or is manually input into the device. Angle A is typically either measured (or alternatively calculated as 180+angle B), and is entered into memory 42 of resource device 14 as resource device position data 50.

During the resource device discovery process, direction-finding module 60 is configured to find the direction (angle C) of signal 18 received at resource device 14, utilizing the direction-sensing receiver 38a and compass 40. Direction finding module 60 is also configured to compute the direction from the wireless device to the resource device (angle E) by subtracting angle C from 180 degrees. Direction-finding module 78 is configured to measure the direction (angle D) of the signal originating at the wireless device and received at the locating device, utilizing direction-sensing receiver 76 and compass 70. As discussed above, this information is sent from the locating device to the resource device, via communication link 80.

Distance-computing module 62 of resource device 14 is configured compute the distance (WR) from resource device 14 to wireless device 20. To accomplish this, distance-computing module 62 is configured to access static device position data 49 and obtain angle A, angle B, and RL, typically stored in memory 42. Distance-computing module 62 is further configured to receive locating device-relative wireless device position data 96, including angle D, from locating device 16 via communication link 80. Distance-computing module 62 typically performs the calculations outlined below to solve for WR.

Solving for |WR|:

WR/sin(WLR)=RL/sin(RWL)

WR=(RL*sin(WLR))/sin(RWL)

WR=RL*sin(D−B)/sin(180−(A−C)−(D−B))

WR=RL*sin(D−B)/sin(A−C+D−B)

Typically, after the position of the wireless device is calculated, angle E and distance WR are sent from a resource device to the wireless device as transmitted wireless device position data 22a contained within response signal 22.

FIGS. 4 and 5 relate the parameters shown in FIG. 3, to the data representations shown in FIG. 1. Thus, angle A is shown to be included within resource device position data 50, angle B is included within locating device position data 52, and RL is included within distance 54. Collectively data 50-54 are included within static device position data 49. These parameters are typically input into resource device 14 and locating device 16 upon installation, as described above, and are thus referred to as set-up parameters 48. Further, angle C, angle E, and WR are each considered printer-relative wireless device position data 94, while angle D is locating device-relative wireless device position data 96. Data 94 and 96 form wireless device position data 92, which, in turn, is included within detected/calculated parameters 90, since this data is detected during the resource device discovery process initiated by the wireless device 20. Transmitted wireless device position data is indicated at 22a and identifies the portion of the wireless device position data 96 that is transmitted to the wireless device 20 in response signal 22.

FIG. 6 depicts an embodiment of system 10 that includes a plurality of wireless devices 20d-20f, which are configured to emit search signals 18d-18f to resource device 14 and locating device 16, respectively. In addition, wireless devices 20d-20f are configured to receive corresponding response signals 22d-22f. Typically each of search signals 18d-18f includes a signature characteristic that enables it to be distinguished from other search signals. For example, a device identifier may be transmitted in the search signals or the search signals may utilize spread spectrum technology and have a unique pattern of signal hopping by which they may be distinguished from one another. Response signals 22d-22f also include such signature characteristics, such that each wireless device is able to distinguish and identify the response intended for it. In this manner, a plurality of users of wireless devices may utilize the present invention simultaneously to find various desired resource devices in a multi-user environment such as a workplace or airport.

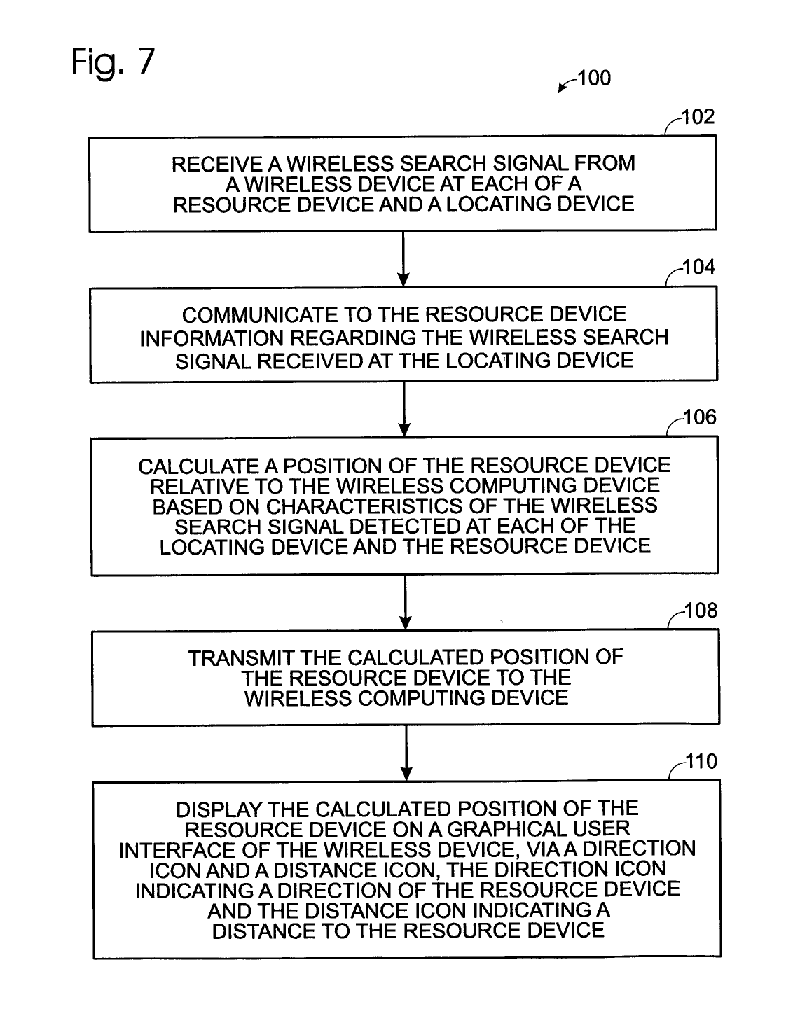

FIG. 7 illustrates a method 100 according to one embodiment of the present invention. Method 100 includes, at 102, receiving a wireless search signal from a wireless device at each of a resource device and a locating device. At 104, the method may further include communicating to the resource device a information regarding the wireless search signal received at the locating device. The information may be, for example, a measured direction, such as angle D, from the locating device to the wireless device. At 106, the method includes calculating a position of the resource device relative to the wireless computing device based on characteristics of the wireless search signal detected at each of the locating device and the resource device. Typically the position is represented as a direction and distance from the wireless device to the resource device. At 108, the method includes transmitting the calculated position of the resource device to the wireless computing device. At 110, the method typically includes displaying the calculated position of the resource device on a graphical user interface of the wireless device. The calculated position may be displayed via a direction icon and a distance icon, the direction icon indicating a direction of the resource device and the distance icon indicating a distance to the resource device. Typically the resource device is a printing device, although a wide variety of resource devices may be used, as discussed above.

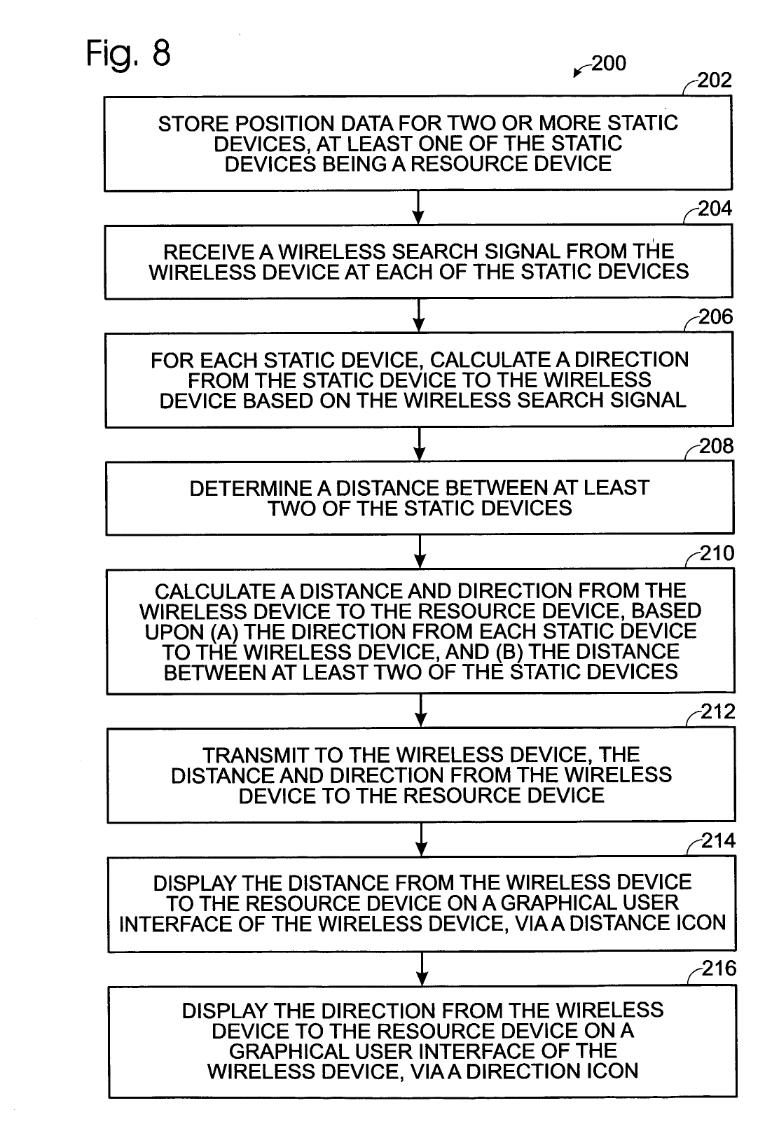

FIG. 8 illustrates a method 200 according to another embodiment of the present invention. Method 200 typically includes, at 202, storing position data for two or more static devices, at least one of the static devices being a resource device. The position data may include a distance (RL) between the devices, and angles A and B. At 204, the method typically includes receiving a wireless search signal from the wireless device at each of the static devices. At 206, the method typically includes, for each static device, calculating a direction from the static device to the wireless device based on the wireless search signal. This may include, for example, calculating the directions indicated by angles C and D. At 208, the method typically includes determining a distance between at least two of the static devices. The distance may be RL, stored at 202, as described above.

At 210, the method typically includes calculating a distance and direction from the wireless device to the resource device, based upon (a) the direction from each static device to the wireless device, and (b) the distance between at least two of the static devices. The distance and direction from the wireless device to the resource device may be distance PD and angle E above. At 212, the method typically includes transmitting to the wireless device, the distance and direction from the wireless device to the resource device. At 214, the method typically includes displaying the distance from the wireless device to the resource device on a graphical user interface 81 of the wireless device, via a distance icon 86. At 216, the method typically includes displaying the direction from the wireless device to the resource device on a graphical user interface of the wireless device, via a direction icon 88. Typically, the resource device is a printing device, although a wide variety of resource devices may be utilized, as described above.

The present disclosure has industrial applicability to the wireless device and resource device industries in that they may be used to enable a wireless device user to quickly and easily locate a resource device in an unfamiliar environment.

While the present embodiments have been particularly shown and described, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

What is claimed is:

1. A method for determining a location of a resource device relative to a wireless computing device, the method comprising:
receiving a wireless search signal from the wireless device at each of the resource device and a locating device; and
calculating a position of the resource device relative to the wireless computing device based on characteristics of the wireless search signal detected at each of the locating device and the resource device.

2. The method of claim 1, further comprising:
transmitting the calculated position of the resource device to the wireless computing device.

3. The method of claim 2, further comprising:
displaying the calculated position of the resource device on a graphical user interface of the wireless device.

4. The method of claim 3, further comprising:
displaying a direction icon on the wireless device, the direction icon indicating a direction to the resource device.

5. The method of claim 3, further comprising:
displaying a distance icon on the wireless device, the distance icon indicating a distance to the resource device.

6. The method of claim 1, further comprising:
communicating to the resource device information regarding the wireless search signal received at the locating device.

7. The method of claim 1, wherein the resource device is a printing device.

8. A method for determining a distance and a direction from a wireless device to a resource device, the method comprising:
storing position data for two or more static devices, at least one of the static devices being a resource device;
receiving a wireless search signal from the wireless device at the static devices;
for each static device receiving the wireless search signal, calculating a direction from the static device to the wireless device based on the wireless search signal;
determining a distance between at least two of the static devices; and
calculating a distance and direction from the wireless device to the resource device, based upon (a) the direction from each static device to the wireless device, and (b) the distance between at least two of the static devices.

9. The method of claim 8, further comprising:
transmitting to the wireless device, the distance and direction from the wireless device to the resource device.

10. The method of claim 9, further comprising:
displaying the distance from the wireless device to the resource device on a graphical user interface of the wireless device, via a distance icon.

11. The method of claim 9, further comprising:
displaying the direction from the wireless device to the resource device on a graphical user interface of the wireless device, via a direction icon.

12. The method of claim 9, wherein the resource device is a printing device.

13. A system for determining the position of a resource device relative to a wireless device, the system comprising:
two or more static devices configured to receive a wireless search signal from the wireless device, at least one of the static devices being a resource device configured to interact with the wireless device;
wherein one of the static devices is configured to calculate a position of the resource device relative to the wireless device, based on characteristics of the wireless search signal received at each of the two or more static devices, and is further configured to transmit the calculated position to the wireless device.

14. The system of claim 13, wherein the resource device is a printing device.

15. The system of claim 13, wherein at least one of the static devices is a locating device.

16. The system of claim 13, wherein each of the static devices includes a direction-sensing receiver configured to determine a search-signal direction from which the wireless search signal is being received by the static device.

17. The system of claim 16, wherein each of the static devices includes a compass.

18. The system of claim 17, wherein each of the static devices includes a direction-finding module configured to measure the search signal direction relative to North.

19. The system of claim 18, wherein the position data includes direction and distance from the wireless computing device to the resource device.

20. The system of claim 19, wherein the resource device is configured to transmit the calculated direction and distance to the wireless device.

21. The system of claim 19, wherein at least one of the static devices includes a triangulation module configured to receive the detected search signal directions from each static device and perform a triangulation calculation to determine the distance and direction from the wireless computing device to the resource device.

22. The system of claim 21, wherein the triangulation engine is configured to receive as input for the triangulation calculation the distance between the resource device and each of the other static device(s) and the angles relative to North formed by a line connecting each of the other static device(s) and the resource device.

23. The system of claim 13, wherein the wireless device is selected from the group consisting of portable computer, personal data assistant, wireless and telephone.

24. The system of claim 13, wherein the resource device is configured to distinguish between a plurality of search signals sent from a corresponding plurality of wireless devices.

25. The system of claim 24, wherein the resource device is further configured to calculate a position of each of the plurality of resource devices relative to the wireless device, based on characteristics of the corresponding wireless search signal received at each of the two or more static devices, and to transmit the calculated position to the corresponding wireless device.

26. A printing device, comprising:
a print mechanism configured to print a print job from a wireless device on a print medium; and
a direction-sensing receiver configured to receive a signal from a wireless device and determine the direction from which the signal was received.

27. The printing device of claim 26, further comprising:
a position-determining module configured to determine the position of a wireless device, based on the received signal.

28. The printing device of claim 26, wherein the position-determining module includes a triangulation module configured to perform a triangulation calculation to determine the direction and distance from the wireless device to the printing device.

29. The printing device of claim 28, further comprising a compass configured to determine North.

30. The printing device of claim 29, wherein the wireless-device-position determining module is configured to interact with the compass and measure the direction from the wireless device to the printing device in relation to North.

31. The printing device of claim 28, further comprising a transmitter configured to transmit the determined direction and distance to the wireless device.

32. A locating device for use with a wireless device and a resource device, comprising:
a compass;
a direction-sensing receiver configured to receive a signal from a wireless device and determine a direction from the static locating device to the wireless device; and
a network interface configured to transmit the determined direction to an associated resource device.

33. The locating device of claim 32, further comprising:
a direction-finding module linked to the compass and direction-sensing receiver, the direction-finding module being configured to determine the direction of the locating device from the wireless device relative to North.

34. The locating device of claim 32, further comprising:
memory configured to store locating device position data.

35. The locating device of claim 34, wherein the network interface is further configured to transmit locating device position data to the resource device.

36. A graphical user interface for a wireless device, comprising:
a direction icon configured to indicate a calculated direction to a resource device; and
a distance icon configured to indicate a calculated distance to a resource device.

37. The graphical user interface of claim 32, wherein the resource device is a printing device.

38. The graphical user interface of claim 32, wherein the direction and distance are calculated at the resource device and transmitted to the wireless device.

39. The graphical user interface of claim 32, wherein the wireless device is configured to emit a search signal and the direction and distance indicated by the direction icon and the distance icon are calculated based on characteristics of the search signal measured at the resource device and at an associated locating device.

40. A computer network capable of accessing a storage medium having embodied therein a program of instructions executable by the computer network to determine a distance and a direction from a wireless device to a resource device by:
storing position data for two or more static devices, at least one of the static devices being a resource device;
receiving a wireless search signal from the wireless device at the static devices;
for each static device receiving the wireless search signal, calculating a direction from the static device to the wireless device based on the wireless search signal;
determining a distance between at least two of the static devices; and
calculating a distance and direction from the wireless device to the resource device, based upon (a) the direction from each static device to the wireless device, and (b) the distance between at least two of the static devices.

41. The method of claim 40, further comprising:
transmitting to the wireless device, the distance and direction from the wireless device to the resource device.

42. The method of claim 41, further comprising:
displaying the distance from the wireless device to the resource device on a graphical user interface of the wireless device, via a distance icon.

43. The method of claim 41, further comprising:
displaying the direction from the wireless device to the resource device on a graphical user interface of the wireless device, via a direction icon.

44. A storage medium having embodied therein a program of instructions for determining a distance and a direction from a wireless device to a resource device using position data for two or more static devices, at least one of the static devices being a resource device, the program of instructions being executable by a computer to:
receive a wireless search signal from the wireless device at the static devices;
calculate a direction from the static device to the wireless device based on the wireless search signal for each static device receiving the wireless search signal;
determine a distance between at least two of the static devices; and
calculate a distance and direction from the wireless device to the resource device, based upon (a) the direction from each static device to the wireless device, and (b) the distance between at least two of the static devices.

45. The method of claim 44, further comprising:
transmitting to the wireless device, the distance and direction from the wireless device to the resource device.

46. The method of claim 45, further comprising:
displaying the distance from the wireless device to the resource device on a graphical user interface of the wireless device, via a distance icon.

47. The method of claim 45, further comprising:
displaying the direction from the wireless device to the resource device on a graphical user interface of the wireless device, via a direction icon.

48. A locating device for use with a wireless device and a resource device, comprising:
compass means;
receiver means for receiving a signal from a wireless device and determining a direction from the static locating device to the wireless device; and
network interface means for transmitting the determined direction to an associated resource device.

49. The locating device of claim 48, further comprising:
direction-finding means for determining the direction of the locating device from the wireless device relative to North, the direction-finding means being linked to the compass means and the receiver means.

50. The locating device of claim 48, further comprising:
memory means for storing locating device position data.

51. The locating device of claim 50, wherein the network interface means is further configured for transmitting locating device position data to the resource device.
